(19) United States
(12) Patent Application Publication
(10) Pub. No.: US 2012/0112910 A1
(43) Pub. Date: May 10, 2012

(54) Cargo Container Self-Arming Monitoring And Security Device

(75) Inventor: Richard C. Meyers, Longboat Key, FL (US)

(73) Assignee: System Planning Corporation, Inc., Arlington, VA (US)

(21) Appl. No.: 13/274,341

(22) Filed: Oct. 16, 2011

Related U.S. Application Data
(60) Provisional application No. 61/411,264, filed on Nov. 8, 2010.

(51) Int. Cl. G08B 13/08

(52) U.S. Cl. 340/547

(57) ABSTRACT

This invention describes an apparatus for securing and monitoring cargo containers. In particular, the present invention discloses the use of a combination of hall effect sensors, permanent magnets, optic sensors, and inductive sensors attached to a surface. This tamper-proof magnetic alarming unit can detect its location and can trigger an alarm if it is moved or if a door is breached.

### BACKGROUND OF THE PRESENT INVENTION

1. Field of the Present invention

The present invention relates to an apparatus and system for securing and monitoring cargo containers. More particularly, the present invention discloses the use of a combination of hall effect sensor, magnet, visual sensor/optic sensor, and inductive sensor (proximately) attached to a surface (such as a door). This tamper-proof monitoring unit can detect its location and can trigger an alarm if the unit is moved or if a door is breached. The apparatus for tamper-proof detection is intended to be mounted to a cargo container with interfacing capabilities to adapt to a smart cargo containers configuration.

2. Description of Related Art

Containerized shipping is a critical component of domestic and international trade. The fourth element of the 2002 Container Security Initiative (CST) calls for smarter, tamper evident shipping containers. However, retrofitting and/or replacing existing shipping containers requires significant time and expense. The purpose of the present invention is to function as an anti-tamper, anti-penetration device adaptable to new cargo container models or for retrofitting existing models.

In today's security conscious transportation environment, there is a strong need to cost-effectively and accurately monitor the contents of containerized shipments. This need exists both in the United States and abroad. Despite the strong need, until recently few solutions, if any, have been able to provide the protection and accuracy needed to suit the transportation industry and the government agencies charged with monitoring shipments. This lack of an acceptable solution is due to many factors which complicate interstate and international shipping.

Shipping containers are used to transport most of the commerce entering, leaving, and transiting or moving within the United States. It is estimated that there are over six million containers moving in global commerce. Shipping containers have revolutionized the transportation of goods by greatly reducing the number of times goods must be loaded and unloaded during transport. However, at the same time, this same advantage has created a major problem in that it is very difficult to monitor and track the contents of each container during transport.

Beyond their basic construction, monitoring the content of shipping containers is also difficult because these containers are carried through numerous transit points and depots all over the world and it is impractical to stop and check the contents of each container individually at each point of transit. Dealing with this problem, the U.S. Customs Service estimates it can inspect just 5% of the 6 million containers entering and reentering the U.S. each year. Accordingly, as of 2002, agencies such as the United States Customs Service began implementing the Container Security Initiative (CSI) seeking improved ways to achieve cargo container security and integrity upon arrival at the ports of entry of the United States.

### SUMMARY OF THE PRESENT INVENTION

The present application discloses a cargo container monitoring and security device designed to warn of intrusion, transmit location, and deter unwarranted breaches of security. Embodiments of this system include both self-arming and stand alone applications, as well as configurations to interface with new or existing processing systems, sensor suites, and communication devices and means. The invention uses a suite of sensors, which may include a hall effect sensor, permanent magnets, optic sensors, and inductive sensors. Mounted on either the interior or exterior of a cargo container, the unit may be self-armed, remotely armed or manually armed at the completion of stuffing.

The object of the present invention is to overcome the shortcomings disclosed in the prior art. The accompanying drawings, which are incorporated in and constitute part of the specification, illustrate various embodiments of the present invention and together with the description, serve to explain the principles of the present invention.

### BRIEF DESCRIPTION OF THE DRAWINGS

FIG. 1 shows a schematic front view of a monitoring unit according to an embodiment of the present invention.

FIG. 2 is a schematic rear view of the monitoring unit of FIG. 1.

FIG. 3 is a schematic view of the monitoring unit attached to a cargo container according to an embodiment of the present invention.

FIG. 4a is a schematic side view of the monitoring unit according to an embodiment of the present invention.

FIG. 4b is a schematic side view of the monitoring unit according to an embodiment of the present invention.

FIG. 5 is a schematic side view of the monitoring unit according to an embodiment of the present invention.

FIG. 6 is a block diagram of a cargo container monitoring system according to an embodiment of the present invention.

FIG. 7 is a functional configuration of a sensing control element according to an embodiment of the present invention.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended and such alterations and further modifications in the illustrated devices are contemplated as would normally occur to one skilled in the art.

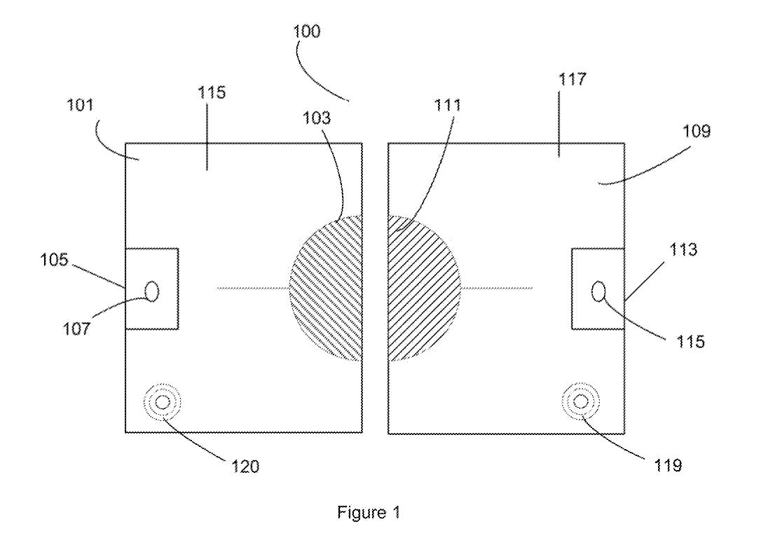

With reference now to FIG. 1, a schematic front view of the monitoring unit 100 will now be discussed. As shown in FIG. 1, the front view of the monitoring unit 100 includes a first element 101 and a second element 109. The first element includes a large permanent magnet 103 encased in outer casing 115, a first hall effect sensor 105, a first hall effect sensor indicator light 107, and a first strobe diode 120. As further shown in FIG. I, the front view of second element 109 is shown including: a second large permanent magnet 111 encased in outer casing 117, a second hall effect sensor 113, a second hall effect sensor indicator light 115 and a second strobe diode 119.

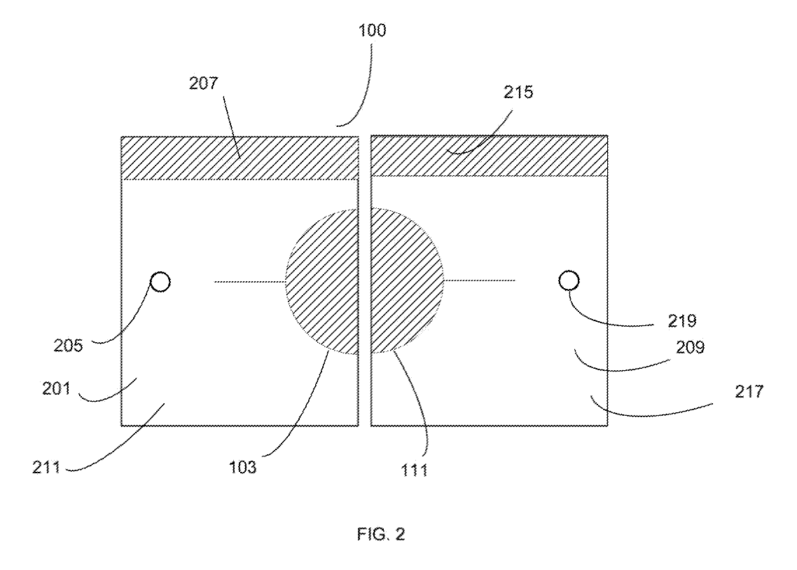

With the reference now to FIG. 2, a schematic rear view of the monitoring unit of FIG. 1 will now be discussed. As shown in FIG. 2, the first element 201 includes a permanent magnet 103, a left optical sensor unit 205 and a magnetic mounting bracket 207 which is attached to an outer casing 211. As further shown in FIG. 2, the second element 209 includes a second large permanent magnet 111, a right optical sensor unit 219 and a magnetic mounting bracket 215 which is attached to an outer casing 217.

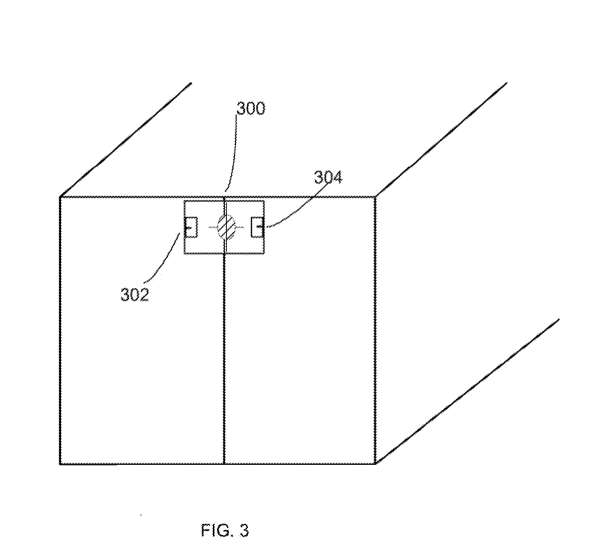

With reference now to FIG. 3, a preferred embodiment of the present invention as seen mounted externally on the door of a cargo container will now be discussed. As shown, a monitoring unit 300 which includes of a first element 302 and a second element 304. In accordance with a preferred embodiment, the monitoring unit 300 is preferably placed on a container door such that the first element 302 is attached to a single container door and the second element 304 is attached to the opposite container door. Preferably, the magnet elements are placed along their respective door seams so that when the doors are closed, the magnetic switch sensor of the monitoring unit 300 is closed.

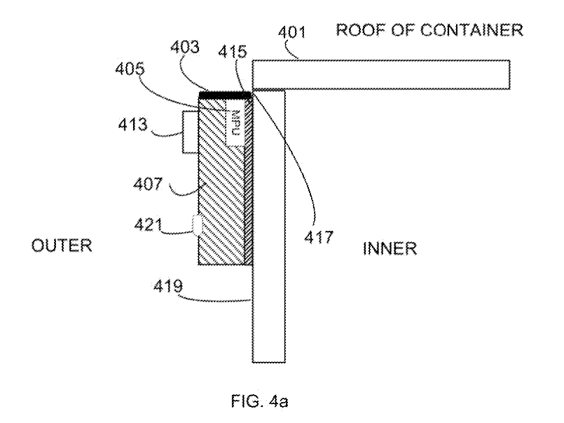

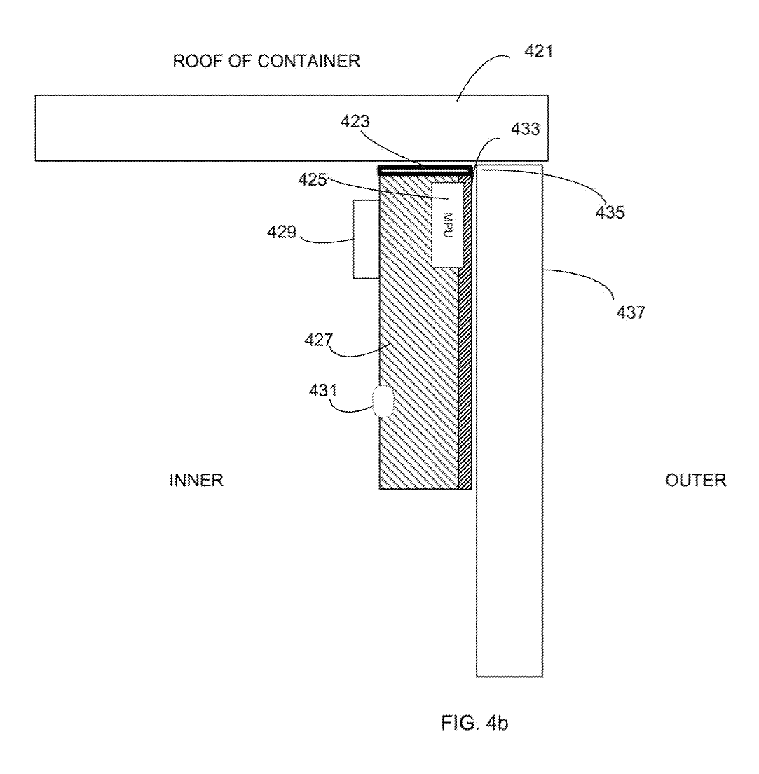

With reference now to FIG. 4a, a detailed description of a monitoring unit in accordance with a preferred embodiment of the present invention will now be discussed. As shown in FIG. 4a, the present invention may be attached to the top most exterior surface 417 of a container door 419 and positioned flush with the door seam of the container door. Further, the outer casing 403 surrounding the entirety of a large permanent magnet 407 may be attachably affixed to a second magnet 415. The second magnet 415 is preferably configured to adhere to the exterior surface of the top most edge of the seam 417 of the container door 419. As further shown in FIG. 4a, the monitoring unit may further include an internal microcontroller unit 405, a hall effect sensor 413, and a strobe diode 421.

With reference now to FIG. 4b, additional details of the monitoring unit will now be discussed. As shown in FIG. 4b, the present invention may be attached to the top most interior surface 435 of a container door 437 and positioned flush with the door seam of the container door beneath the interior surface of the roof of the container 421. As further shown in FIG. 4b, an outer casing 423 may be provided to surround the entirety of the permanent magnet 427. The outer casing 423 may be attachably affixed to a second magnet 433. The second magnet adheres to the interior surface of the top most inner edge 435 of a cargo container door 437. As further shown in FIG. 4b, the internal microcontroller unit 425, a hall effect sensor 429, and a strobe diode 431 are provided. With reference to FIG. 4b, this embodiment of the present invention may require an automatic and/or remote arming sequence as the unit will be inside cargo container and inaccessible when armed. An advantage to this embodiment is that the monitoring unit is undetectable.

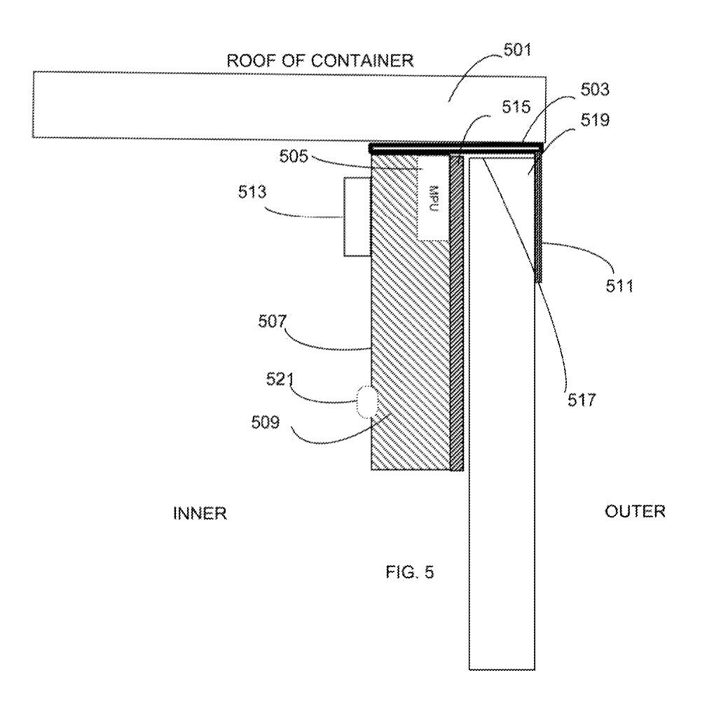

With reference now to FIG. 5, a preferred embodiment of the monitoring unit 100 of the present invention will now be discussed. As shown in FIG. 5, a permanent magnet 509 with an outer casing 507, a microcontroller unit 505, a strobe diode 521 and a hall effect sensor 513 are provided. As shown, the outer casing 503 may be configured to span the top most exterior surface of a container door 517. Alternatively, the outer casing 503 may attachably affix to a second magnet 515 to secure the monitoring unit 100. In this embodiment, the second magnet 515 preferably adheres to the interior surface of a container door so that it is flush with the seam of the door.

As further shown in FIG. 5, a metal mounting bracket 511 extending over the outer edge of a container door 519 and along the exterior surface of a container door to provide additional support to the monitoring unit. Additionally, the metal mounting bracket 511 in this embodiment may house a pass-through antenna as means of improving wireless communication links by receiving RF signals from within a container and guiding RF signals outside of a container. This embodiment of the present invention may also require an automatic and/or remote arming sequence as the unit will be inside cargo container and inaccessible when armed. An advantage to this embodiment is that the monitoring unit is undetectable, tamper-proof and securely mounted.

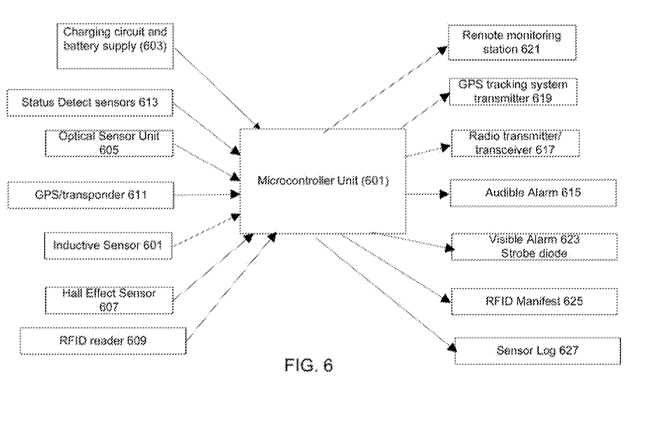

With reference now to FIG. 6, a block diagram illustrating a preferred embodiment of the present invention will now be discussed. As shown, a microcontroller unit 601 receives input from a charging circuit and battery cells 603, an optical sensor unit 605, an inductive sensor 601, a hall effect sensor 607, an RFID reader 609, the status detect sensors 613 and a GPS transponder 611. The microcontroller unit 601 then assesses all the information and sends out signals to an audible alarm 615, a radio transmitter/transceiver 617, a GPS tracking system transmitter 619, a visible alarm 623, an RFID manifest 625, a sensor log 627, and a remote monitoring station 621. Data from these sensors is processed, stored, and acted upon by the microcontroller unit 601.

The monitoring unit is intended to give a remote indication of any attempted interference with the doors of containers or metal doors. The system is designed for minimal user attention and only requires the user to attach, activate and deactivate the device via an RFID card, security code or the like. Automatic arming is achieved as permanent magnets 103, 111 connect when the two parts of the monitoring unit make contact at the door seam of a container.

Preferably, the monitoring unit of the present invention includes circuitry and digital ports to connect to existing electrical and sensor management systems of a cargo container previously configured with embedded circuitry. In operation, the microcontroller unit 601 is preferably programmed to routinely scan the condition of each sensor to ensure operability.

Alarming

The declaration of an alarm event is a result of sensor data fusion, sensor performance sequencing, and contextual supporting data. When the controller declares an alarm event, it may activate a visible element, such as strobe diode 623, or via an audible alarm 615. Each alarm is preferably date and time stamped into flash memory along with the relevant details of the alarm event. The alarm messages will expose the data and rationale for the event declaration to allow for troubleshooting and visual inspection by the carrier before the shipper or customs agent are obligated to respond. This data also can be forwarded to a central location for scrutiny prior to dispatching an inspector to decrease the possibility of a false alarm response.

Manual Arming Sequence

In a first mode, a user may attach a monitoring unit to a container door. According to a preferred embodiment, the user may run a pre-alarming sequence to input a necessary code and container number, run diagnostics to check the power of the magnets and sensors, confirm placement of the monitoring unit, and transmit a wireless ping followed by location data to a remote monitoring station and/or homebase. Preferably, the RFID reader of the monitoring unit will also query interior contents of a cargo container and record and transmit data to a homebase to be crosschecked to verify that items in the cargo container are properly paired with the monitoring unit.

In a second mode, when the left and right halves of the permanent magnetic 103, 111 of the monitoring unit make contact across the door seam, the device may be armed and the hall effect sensor indicator light may be illuminated. If the cargo door is forced opened while the unit is armed, the unit may audibly sound while simultaneously alerting the remote monitoring station or home base of a breach in security.

Automatic Arming Sequence

With further reference to FIG. 1, according to a preferred embodiment, in a first mode, a user may manually attach a monitoring unit 100 to a container door. In a second mode, when the left and right halves of the permanent magnetic 103, 111 of the proximity sensor unit are joined across the door seam, the device is armed and the hall effect sensor indicator light is illuminated. Once armed the monitoring unit may automatically run diagnostics to check the strength of magnets, status of sensors, and the optical confirmation of placement and then transmit a wireless ping followed by transmission of location data to a remote monitoring station and/or home base. Preferably, the RFID reader of the monitoring unit may also query interior contents of the container and record and transmit data to a home base to be crosschecked to verify that items in the container are properly paired with monitoring unit. Thereafter, if the container doors are forced opened without disarming the device, the monitoring unit may audibly sound while simultaneously alerting a remote monitoring station or a home base of a breach in security.

Processing System

In operation, the microcontroller unit 601 is preferably programmed to routinely scan the conditions of the sensors to ensure operability. It may be further preferable, that the microcontroller unit 601 have access to all other subsystem managers of the sensor, communications, power, and alerting functions. To achieve this function, it is preferred that the controller 601 has access to and handles all of the system logging of sensor data on a sensor log 627 or similar medium. Further, it is preferred that the microcontroller unit 601 also process and store RFID data (i.e. as an RFID manifest 625 of the container contents) when the system is used in conjunction with an RFID reader.

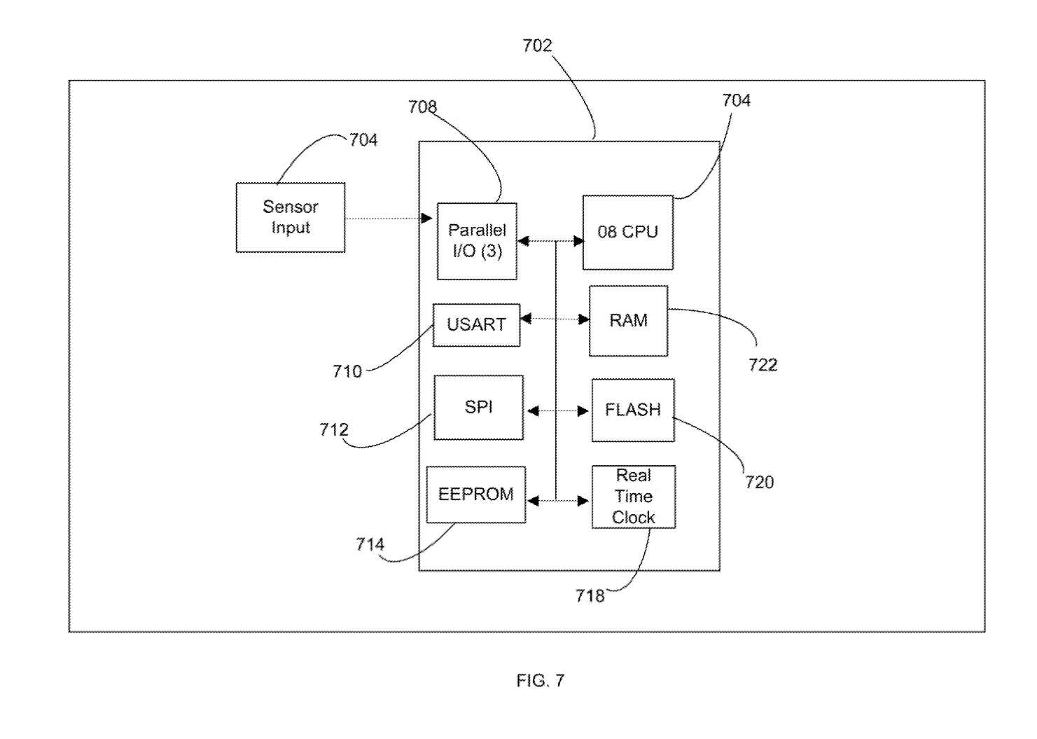

With reference now to FIG. 7, it is preferred that the microcontroller unit 702 incorporates a microprocessor 704, a real time clock 718, a general purpose Input/Output port to support external peripheral control 708, a Universal Synchronous/Asynchronous Receiver Transmitter (USART) 710, a Serial Port Interface (SPI) 712, and memory , such as RAM 722, FLASH memory 720, and EEPROM 714 as shown.

According to a preferred embodiment, the microprocessor 704 used may be a low power, high performance, eight-bit intergrated circuit based on the Motorola HCS08 instruction set. The controller will preferably manage power and host the master date-time clock, communication scheduling and annotation of flash memory records.

Communication System

In accordance with a preferred embodiment of the present invention, the reporting may be made via a wireless connection to a satellite mode to communicate with a satellite system such as Globalstar or Orbcomm. Preferably, such a satellite device will be a device such as the Axxon, AutoTracker, or the like, or a customized Orbcomm VHF satellite GPS tracking communications device which may be adapted with Zigbee interface antenna devices to incorporate them into the overall LAN architecture of the security system; these devices include a satellite transceiver, GPS receiver, a customized Zigbee wireless antenna with a serial (Ax Tracker) or duplex (OrbComm) interface.

In accordance with an alternative preferred embodiment of the present invention, the reporting may also be made using a wireless system independent from the satellite system. According to this embodiment, Wireless signals may be transmitted to a wireless relay, base station or the like for routing and transmission to a chosen centralized location independent from or in combination with the transmissions made from the satellite system. In accordance with this alternative embodiment, signals may also be received by the communications manager and wireless interface from such external wireless networks as well.

According to a preferred embodiment of the present invention, it is preferred that the wireless communications used within the present invention will be based on the Zigbee (IEEE 802.15.4) standard. This standard transmits RF signals in the 2.4 GHz ISM band and operates with low power consumption due to its relatively slower data transmission rate (128 Kpps-250 Kbps).

As referred to above, all communications of the present invention may be designed to be duplex or simplex in nature. Further, as needs require, the processes for transmitting data to and from the present invention may be designed to be push or pull in nature. Still further, each feature of the present invention may be made to be remotely activated and accessed from distant monitoring stations. Accordingly, data may be uploaded to and downloaded from the present invention as needed. For example, as detailed above, each system and subsystem of the present invention may be designed to send, receive, report and request information via the wireless and/or satellite systems so as to continually maintain and update the container systems.

Additional communications with the communications manager are preferably enabled via industry standard wired interfaces, with communications protocols implemented in firmware for future upgrade. These interfaces preferably will include at least two RS-322 compatible serial ports. These alternate serial ports may assist the communications manager to interface with additional remote sensors as well as other local reader/controllers such as an RFID reader or other devices.

Remote Monitoring

To support and monitor the dataflow generated by the present invention, it is preferred that users establish a centralized location to collect and analyze data. This central location or “data fusion center” would preferably consolidate all tracking signals, sensor alarms and reports generated by the monitoring systems and provide further context and links with current intelligence.

Preferably, such a data fusion center will receive such source information in a variety of formats such as Electronic Data Interchange, XML, E-mail, HTML and flat text files. After receiving such data, the data fusion center preferably would act to process information to identify anomalies. With this data collected and processed, analyst may calculate statistics and probability of detection models used for decision support.

In terms of decision making, such a data fusion center would assist agents and shippers in making decisions regarding the safety and status of each container. In short, such a data fusion center would preferably provide a consolidated source of information that could be used to assist agencies and shippers to identify and remove unsafe and suspicious containers from commerce.

What is claimed is:

1. An apparatus for securing and monitoring a container having at least a first door and a second door which are each movable between an open position and a closed position, and which are configured to close together to form a wall portion of the container, the apparatus comprising:
a first housing element configured to attach to the first door, wherein the first housing is comprised of a first magnetic element;
a second housing element configured to attach to a second door, wherein the second housing element is comprised wherein the first housing element and the second housing element are configured to magnetically interact such that when both doors are in a closed position, the first magnetic element operates as a switch to indicate the closed position of the doors.

2. The apparatus of claim 1, wherein at least one of the first or second housing elements are configured to magnetically attach to a door.

3. The apparatus of claim 2, wherein at least one of the first or second housing elements further comprises a sensing element for detecting the position of the apparatus.

4. The apparatus of claim 3, wherein the sensing element comprises a proximate sensing unit, an optical sensing unit, a hall effect sensing unit or an inductive sensing unit.

5. The apparatus of claim 4, wherein the housing element comprises an alarming element for declaring an alarming event.

6. The apparatus of claim 5, wherein the alarming element comprises a strobe diode, an illuminating indicator light, an audible alarm, a means of transmitting an alert or a combination thereof.

7. The apparatus of claim 6, wherein the apparatus further comprises:
a RFID reader;
a GPS tracking system;
a power module;
a controlling element; and
a communications element.

8. A method for securing or monitoring a container, the method comprising the steps of:
attaching a housing element to a first door;
attaching a housing element to a second door;
magnetically joining both housing elements across the door seam in a closed state; and
arming the housing elements for monitoring the closed state.

9. The method of claim 8, further comprising the step of activating a sensing element for detecting the position of the each housing element.

10. The method of claim 9, further comprising the step of running sensing element diagnostics.

11. The method of claim 10, further comprising the step of transmitting a wireless ping for checking the communications element.

12. The method of claim 11, further comprising the step of querying interior contents of the container.

13. The method of claim 12, further comprising the step of transmitting data to a remote monitoring station.

14. An apparatus for securing and monitoring a container, wherein the container includes at least a door and an adjacent door frame in which the door is movable between an open state and a closed state, and further wherein the door is configured to close within the door frame to form a wall portion of the container when the door is moved to a closed state, the apparatus comprising:
a first housing element connected to the door and a second housing element connected to a portion of the door frame adjacent to the first housing element, wherein the housing elements magnetically interact in order to detect and monitor the open or closed state of a door.

15. The apparatus of claim 14, wherein the housing element further comprises a sensing element for detecting the position of the apparatus.

16. The apparatus of claim 15, wherein the sensing element comprises a proximate sensing unit, an optical sensing unit, a hall effect sensing unit or an inductive sensing unit.

17. The apparatus of claim 16, wherein the housing element comprises an alarming element for declaring an alarming event.

18. The apparatus of claim 17, wherein the alarming element comprises a strobe diode, an illuminating indicator light, an audible alarm, a means of transmitting an alert or a combination thereof.

19. The apparatus of claims 18, further wherein the apparatus comprises
a RFID reader;
a GPS tracking system;
a power module;
a controlling element; and
a communications element.
